(19) United States
(12) Patent Application Publication
(10) Pub. No.: US 2008/0162823 A1
(43) Pub. Date: Jul. 3, 2008

(54) SYSTEM AND METHOD FOR HANDLING MULTIPLE ALIASED SHADOW REGISTER NUMBERS TO ENHANCE LOCK ACQUISITION

(75) Inventors: Michael N. Day, Round Rock, TX (US); Charles R. Johns, Austin, TX (US); Roy M. Kim, Austin, TX (US); Peichun P. Liu, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,033

(22) Filed: Jan. 2, 2007

(51) Int. Cl. G06F 12/14; G06F 12/08

(52) U.S. Cl. 711/138; 711/152; 711/E12.021; 711/E12.093

(57) ABSTRACT

Exemplary embodiments include a method for enhancing lock acquisition in a multiprocessor system, the method including: sending a lock-load instruction from a first processor to a cache; setting a reservation flag for the first processor, storing a reservation address, storing a shadow register number, and sending lock data to the first processor in response to the lock-load instruction; placing the lock data in target and shadow registers of the first processor; determining from the lock data whether lock is taken; resending the lock-load instruction from the first processor to the cache upon a determination that the lock is taken; determining whether the reservation flag is still set and its main memory address and shadow register number match with the saved reservation address and shadow register number for the first processor; sending a status-quo signal to the first processor without resending the lock data to the first processor upon a determination that the reservation flag is still set for the first processor; and copying the lock data from the associated shadow register to the target register in response to the status-quo signal.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The invention relates generally to memory management in a multiprocessor system and, more particularly, to enhancing a lock acquisition mechanism.

2. Description of the Background

In a large symmetrical multi-processor system, lock acquisition is frequently used to synchronize access to data structures. Systems that run with producer-consumer types of applications have to make sure that the produced data is globally visible before signaling to the consumers so that they can access the produced data structure. Usually, the producer tries to acquire a lock using a lock-load instruction and verify on a lock-word value. Once the producer application has acquired the lock, the producer application is the owner of the data structure until it releases the lock. The consumer will have to wait for the lock to be released before accessing the data structure.

When attempting to acquire a lock, software “spins” or loops on an atomic update sequence that executes the lock load instruction and compares the data with a software specific definition indicating “lock_free.” If the value is “not free,” a branch back to lock load instruction is taken to restart the sequence. If the value does indicate free, the loop is exited and a conditional lock_store instruction is used to update the lock word to “lock taken.” The lock store fails if the processor attempting to acquire the lock no longer holds the reservation made at lock load time. If this lock store fails, software again restarts the loop beginning with the lock load instruction. This spin loop of continually reading and re-reading the lock word when the lock is taken causes the same data to be retrieved out of cache over and over while the lock is taken by another processing element. Accessing the cache array to get the same data and send it again and again, while the lock is taken by another processor, is power consuming, is wasteful of cache access cycles (in cases of shared caches) and could create system live-lock in a large configuration system.

Therefore, a need exists for a system and method for saving power and preventing a potential live-lock situation.

### SUMMARY OF THE INVENTION

Exemplary embodiments include a method for enhancing lock acquisition in a multiprocessor system, the method including: sending a lock-load instruction from a first processor to a cache; setting a reservation flag for the first processor, storing a reservation address, storing a shadow register number, and sending lock data to the first processor in response to the lock-load instruction; placing the lock data in target and shadow registers of the first processor; determining from the lock data whether lock is taken; resending the lock-load instruction from the first processor to the cache upon a determination that the lock is taken; determining whether the reservation flag is still set and its main memory address and shadow register number match with the saved reservation address and shadow register number for the first processor; sending a status-quo signal to the first processor without resending the lock data to the first processor upon a determination that the reservation flag is still set for the first processor; and copying the lock data from the associated shadow register to the target register in response to the status-quo signal.

Exemplary embodiments also include multiprocessor system with enhanced lock acquisition, including: a first processor; a cache coupled to the first processor, the first processor sending a load-lock instruction to the cache, the cache, in response to the load-lock instruction, setting a reservation flag for the first processor, storing a reservation address, storing a shadow register number, and sending lock data to the first processor; a target register included in the first processor for holding the lock data to determine whether lock is taken; and a shadow register included in the first processor for holding the lock data to provide the lock data to the target register for lock evaluation in response to a status-quo signal from the cache to the first processor, the status-quo signal indicating that the lock is taken and the reservation flag is still set, and its main memory address and shadow register number match with the saved reservation address and shadow register number for the first processor.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which provides a memory management system that saves power and prevents live-lock situations.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating a multiprocessor system with enhanced lock acquisition; and

FIGS. 2A and 2B are a flow diagram illustrating enhanced lock acquisition in a multiprocessor system.

The detailed description explains the preferred embodiments of the invention, together with advantages and features, by way of example with reference to the drawings.

### DETAILED DESCRIPTION OF SPECIFIC EMBODIMENTS

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

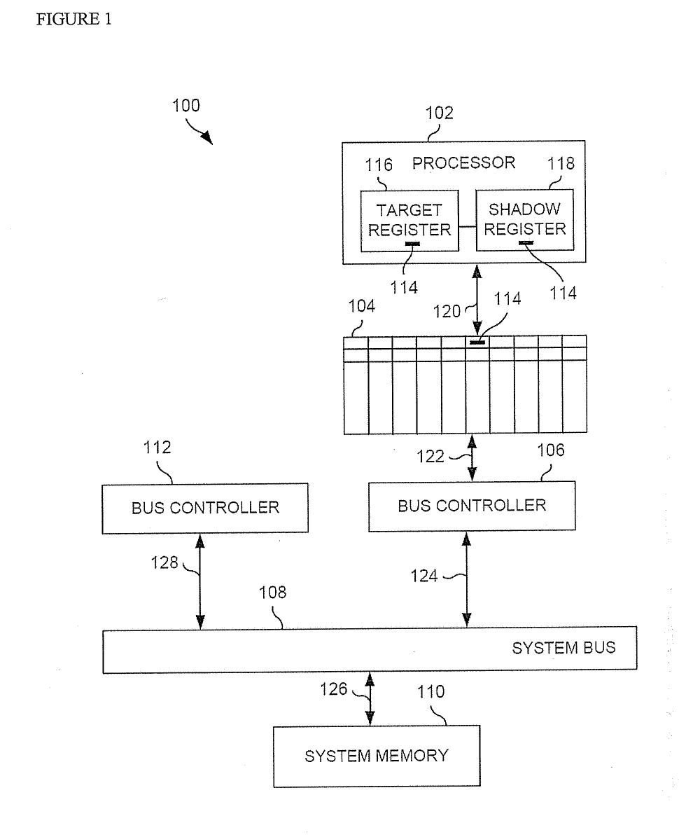

Referring to FIG. 1 of the drawings, the reference numeral 100 generally designates a multiprocessor system with enhanced lock acquisition embodying features of the present invention. The multiprocessor system 100 generally includes a first processor 102, a cache 104, a first bus controller 106, a system bus 108, a system memory 110, and a second bus controller 112. The first processor 102 includes target and shadow registers 116 and 118. Furthermore, the target registers 116 do not have a one-to-one relationship with the shadow registers 118. Any given target register can be associated with any of the shadow register (that is, aliased shadow registers). The first processor 102 is coupled to the cache 104 via a connection 120 for communicating with the cache 104 including loading lock data 114. When the first processor 102 receives the lock data 114 from the cache 104, the first processor 102 places the lock data 114 in both the target register 116 and the shadow register 118. Preferably, the cache 104 is a level 2 (L2) cache of the first processor 102.

The cache 104 is coupled to the first bus controller 106 via a connection 122. The first bus controller 106 is also coupled to the system bus 108 via a connection 124. The system bus 108 is then coupled to the system memory 110 via a connection 126. Therefore, the cache 104 is in communication with the system memory 110 through the first bus controller 106 and the system bus 108. Also, the second bus controller 112 is coupled to the system bus 108 via a connection 128. Another bus master such as a second processor may be coupled to the second bus controller 112 possibly through a second cache.

Generally, the multiprocessor system 100 has one or more additional processors other than the first processor 102. Occasionally, the first processor 102 and any one of the additional processors need to access a particular memory address space and possibly alter the data stored in the particular memory address space. In this case, it is important to reserve that particular memory address space for a single processor at a time. This is achieved by using a reservation flag and lock acquisition. The lock data 114 typically contains information as to which processor has a temporary, exclusive light to access a particular memory address space corresponding to the lock data 114. The reservation flag facilitates the process of lock acquisition by notifying any concerned processors whether they can attempt to acquire lock at a given point in time.

Preferably, the lock data 114 includes a lock word, the value of which reflects whether lock is taken at a particular point in time. For example, the lock word consisting of all zero bits indicates that lock is not already taken on the aforementioned particular memory address space, whereas the lock word consisting of any non-zero bit(s) indicates otherwise. In this example, the first processor 102 checks the lock word and determines whether lock is already taken or not. If lock is already taken, the first processor 102 asks for the lock word repeatedly until the first processor 102 sees the lock word consisting of all zero bits (i.e., until the lock is released).

In a prior art system, the first processor 102 would keep accessing the cache 104 to retrieve the lock data 114 even during the time periods when the lock has not been released (i.e., the lock data 114 is not changed yet). This would translate into both unnecessary power consumption and a hindrance to the overall performance of the cache 114. The first processor 102, does not retrieve the lock data 114 during the time period when the lock is not released yet. Instead, the first processor 102 copies the lock data 114 from the shadow register 118 to the target register 116. Preferably, the cache 104 sends a status-quo signal to the first processor 102 in response to a lock-load instruction from the first processor 102, when the lock is still taken (for example, by another processor). Note that, in a prior art system, old lock data originally retrieved from the cache would probably have been altered, and therefore, could not be reused. Even with attempted improvements on the prior art, first processor 102 has the limitation that each target register is associated with only one of the shadow register, or a one-to-one relationship. Preferably, the cache 104 sends a status-quo signal to the first processor 102 in response to a lock-load instruction from the first processor 102, when the lock is still taken and the association between the shadow register and target register is the same. Without this improvement, incorrect lock data is forwarded if either the shadow or target registers change.

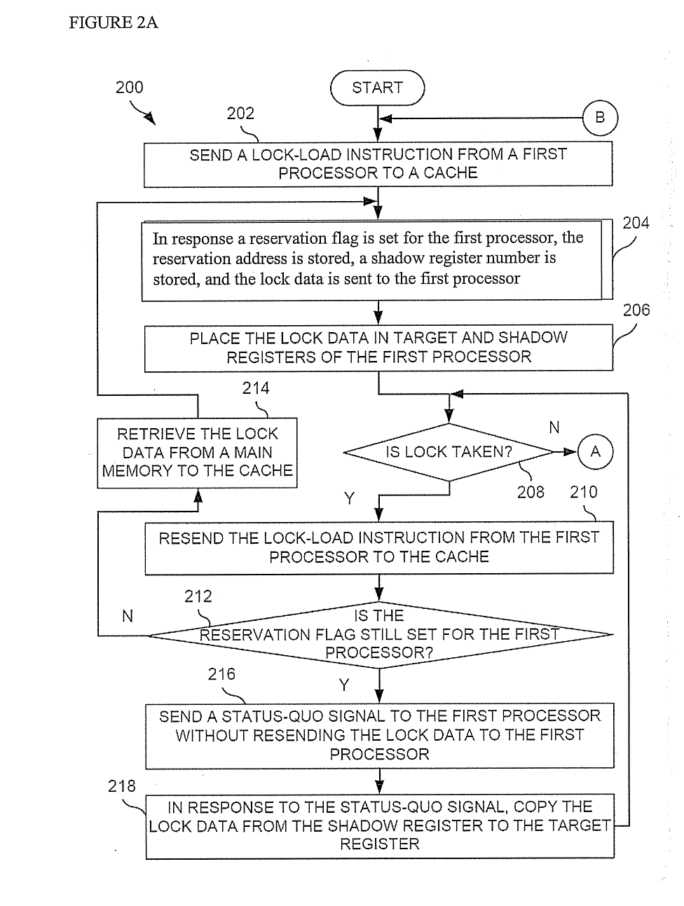

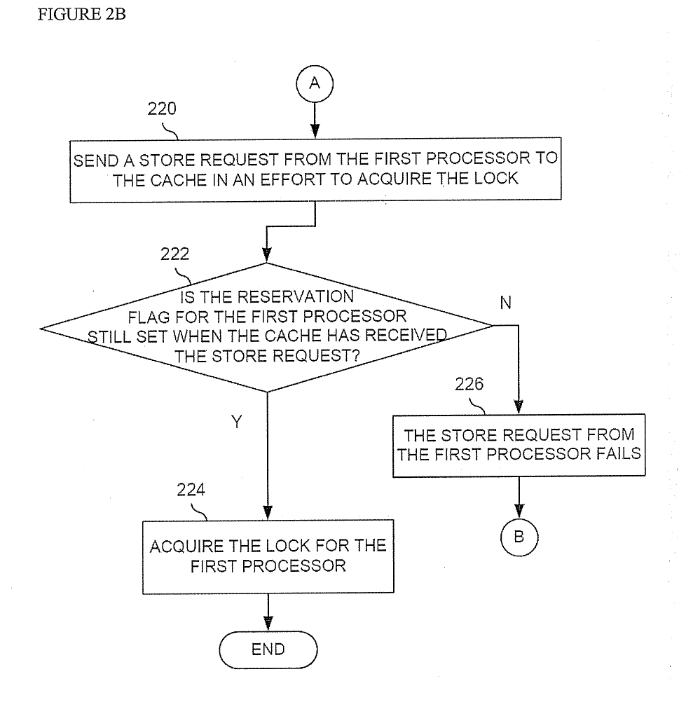

Referring now to FIGS. 2A-B, a flow diagram 200 illustrates enhanced lock acquisition in a multiprocessor system in accordance with embodiments of the invention.

In step 202, a lock-load instruction is sent from a first processor to a cache. For example, the first processor 102 sends the lock-load instruction to the cache 104. The lock-load instruction asks the cache to return lock data. Furthermore, the lock-load instruction associates a shadow register with the target register.

In step 204, in response to the lock-load instruction, a reservation flag is set for the first processor, the reservation address is stored, a shadow register number is stored, and the lock data is sent to the first processor. For example, the cache 104 sets the reservation flag for the first processor 102 and sends the lock data 114 to the first processor 102.

In step 206, the lock data is placed in target and shadow registers of the first processor. For example, the first processor 102 places the lock data 114 in the target register 116 and the shadow register 118.

In step 208, it is determined whether lock is taken. For example, the first processor 102 checks the lock data 114 in the target register 116 and determines whether the lock data 114 indicates that lock is taken. If lock is taken, the process goes to step 210. Otherwise, the process goes to step 220.

In step 210, upon a determination that the lock is taken, the lock-load instruction is resent from the first processor to the cache. For example, the first processor 102 resends the lock-load instruction to the cache 104.

In step 212, it is determined whether the reservation flag is still set and its main memory address and shadow register number match with the saved reservation address and shadow register number for the first processor. For example, the cache 104 checks the reservation flag for the first processor to see if it is still set and checks for addresses match. If it is still set and addresses match, the process goes to step 216. If it is reset, it goes to step 214.

In step 214, upon a determination that the reservation flag for the first processor is reset, the lock data is retrieved from a main memory to the cache. For example, the lock data 114 is retrieved from the main memory 110 to the cache 104. Then, the process goes back to step 204.

In step 216, upon a determination that the reservation flag for the first processor is still set, a status-quo signal is sent to the first processor without resending the lock data to the first processor. For example, the status-quo signal is sent to the first processor 102 without resending the lock data 114 to the first processor 102. This means that the lock data 114 is not retrieved from the cache 104.

In step 218, in response to the status-quo signal, the lock data is copied from the shadow register to the target register. For example, the processor 102 copies the lock data 114 from the shadow register 118 to the target register 116. Then, the process goes back to step 208.

In step 220, upon a determination in step 208 that lock is taken, a store request is sent from the first processor to the cache in an effort to acquire the lock. For example, the first processor 102 sends the store request to the cache 104 in an effort to acquire the lock.

In step 222, it is determined whether the reservation flag for the first processor is still set when the cache has received the store request. For example, the cache 104 determines whether the reservation flag for the first processor 102 is still set when the cache 104 has received the store request from the first processor 102. If the reservation flag is still set, then the process goes to step 224. If the reservation flag is reset before the cache has received the store request, then the process goes to step 226.

In step 224, the lock is acquired for the first processor. For example, the first processor 102 acquires the lock and writes to the lock data to indicate its lock acquisition.

In step 226, the store request from the first processor fails and the process resumes by going back to step 202.

One skilled in the art will understand that the lock-load instruction sent in step 202 can be performed hi two steps to achieve the association between the target and shadow registers. The first step 202 is the request to the cache to return the lock data to a specified shadow register. When either the data is returned in step 204 or the status-quo signal is returned in step 218, a second load is performed in step 206 and step 218 to copy the data from the shadow register to the target.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for enhancing lock acquisition in a multiprocessor system, the method comprising:
sending a lock-load instruction from a first processor to a cache;
setting a reservation flag for the first processor, storing a reservation address, storing a shadow register number, and sending lock data to the first processor in response to the lock-load instruction;
placing the lock data in target and shadow registers of the first processor;
determining from the lock data whether lock is taken;
resending the lock-load instruction from the first processor to the cache upon a determination that the lock is taken;
determining whether the reservation flag is still set for the first processor;
sending a status-quo signal to the first processor without resending the lock data to the first processor upon a determination that the reservation flag is still set and its main memory address and shadow register number match with the saved reservation address and shadow register number for the first processor; and
copying the lock data from an associated shadow register to the target register in response to the status-quo signal.

2. The method of claim 1, further comprising:
upon a determination that the lock is not taken, sending a store request from the first processor to the cache in an effort to acquire the lock;
determining whether the reservation flag for the first processor is still set when the cache has received the store request;
upon a determination that the reservation flag for the first processor is still set when the cache has received the store request, acquiring the lock for the first processor; and
upon a determination that the reservation flag for the first processor is reset when the cache has received the store request, failing the store request for the first processor.

3. The method of claim 2, further comprising:
upon a determination that the reservation flag is reset for the first processor, retrieving the lock data from a system memory to the cache; and
in response to the lock-load instruction, setting the reservation flag for the first processor and sending lock data to the first processor.

4. The method of claim 3, further comprising:
upon copying the lock data from the associated shadow register to the target register, determining from the lock data whether lock is taken.

5. The method of claim 4, wherein the cache is a level 2 (L2) cache of the first processor.

6. The method of claim 5, wherein the lock data includes information on whether lock is taken or not.

7. The method of claim 1, wherein the lock data includes a lock word for indicating whether lock is taken or not.

8. The method of claim 7, wherein the lock word consisting of zero values in all bits indicates that lock is not taken.

9. The method of claim 1, wherein the first processor does not directly work on data placed in the shadow register.

10. The method of claim 1, wherein the reservation flag for the first processor is reset when a store operation is performed on the lock data by a bus master.

11. The method of claim 10, wherein the bus master is a second processor.

12. The method of claim 1, wherein the sending a status-quo signal to the first processor without resending the lock data to the first processor does not require accessing the cache.

13. The method of claim 1, further comprising:
enhancing the lock acquisition by eliminating unnecessary access to the cache for the same lock data.

14. A multiprocessor system with enhanced lock acquisition, comprising:
a first processor;
a cache in signal communication with the first processor, the first processor configured to send a load-lock instruction to the cache, the cache, in response to the load-lock instruction, configured to set a reservation flag for the first processor, store a reservation address, store a shadow register number, and send lock data to the first processor;
a target register included in the first processor configured for holding the lock data to determine whether lock is taken; and
a shadow register included in the first processor configured for holding the lock data to provide the lock data to the target register for lock evaluation in response to a status-quo signal from the cache to the first processor, the status-quo signal indicating that the lock is taken and the reservation flag is still set and its main memory address and shadow register number match with the saved reservation address and shadow register number for the first processor.

15. The multiprocessor system of claim 14, further comprising:
a first bus controller in signal communication with the cache;
a system bus in signal communication with the first bus;
a system memory in signal communication with the system bus; and
a second bus controller in signal communication with the system bus.

16. The multiprocessor system of claim 14, wherein the cache is a level 2 (L2) cache of the first processor.

17. The multiprocessor system of claim 14, wherein the lock data includes information on whether lock is taken or not.

18. The multiprocessor system of claim 14, wherein the lock data includes a lock word for indicating whether lock is taken or not.

19. The multiprocessor system of claim 14, wherein the lock word consisting of zero values in all bits indicates that lock is not taken.

20. The multiprocessor system of claim 14, wherein the first processor does not directly work on data placed in the shadow register.
